(19) United States
(12) Patent Application Publication
(10) Pub. No.: US 2020/0122039 A1
(43) Pub. Date: Apr. 23, 2020

(54) METHOD AND SYSTEM FOR A BEHAVIOR GENERATOR USING DEEP LEARNING AND AN AUTO PLANNER

(71) Applicant: Unity IPR ApS, Copenhagen K (DK)

(72) Inventors: Nicolas Francois Xavier Meuleau, San Francisco, CA (US); Vincent-Pierre Serge Mary Berges, San Bruno, CA (US); Amir Pascal Ebrahimi, Sausalito, CA (US); Arthur William Juliani, JR., San Francisco, CA (US); Trevor Joseph Santarra, South San Francisco, CA (US)

(21) Appl. No.: 16/660,740

(22) Filed: Oct. 22, 2019

Related U.S. Application Data
(60) Provisional application No. 62/749,018, filed on Oct. 22, 2018.

(51) Int. Cl. A63F 13/57; G06N 20/00; G06N 3/02

(52) U.S. Cl. CPC A63F 13/57; G06N 3/02; G06N 20/00

(57) ABSTRACT

A method of behavior generation is disclosed. Planning state data in a planning domain language format is received and a state description and an associated action description based on the planning state data are generated. The state description and the associated action description are parsed into a series of tokens for a machine learning encoded state and associated ML encoded action. The series of tokens describe the state and the action. The ML encoded state and ML encoded action is processed with a recurrent neural network to generate an estimate of a value of the state description and the action description. Output of the RNN is taken as input into a neural network to generate a value estimate for a state-action pair. A plan that includes a plurality of sequential actions for an agent is generated. The plurality of sequential actions is chosen based on at least the value estimate.

### CROSS-REFERENCE TO RELATED APPLICATIONS

This application claims the benefit of U.S. Provisional Application No. 62/749,018, filed Oct. 22, 2018, which is incorporated by reference herein in its entirety.

### TECHNICAL FIELD

The present invention relates generally to the field of artificial intelligence, and, in one specific example, to behavior generation systems and methods.

### BACKGROUND OF THE INVENTION

In the world of video games, interactive simulations and robotics, Artificial Intelligence (AI) is used to generate various behaviors. A purpose of generating the behaviors may be to achieve a goal specified by a user. In general, there may be two levels, or scales, over which the behaviors are generated; the first level works at the individual character scale, while the second works at the scale of an entire world (e.g., game world, simulation environment or real world) as in story generation. An example of the first level involves non-player characters (NPCs) in video games and can also be seen in robotics. At this first level, a typical goal would be to generate high-level agent behavior, which might include a list of activities to perform over time, a series of places to travel to, and generally governing what the agent does at the highest level of abstraction (as opposed to low level behaviors such as character navigation and animation). An example of the second level involves generating behaviors that drive the narration of a story through certain points. The goal for storytelling in games and simulations is to generate, enable and disable events, quests and other opportunities for a player to act on.

Some approaches to behavior and story generation may use a paradigm which we refer to herein as “reactive AI” wherein behaviors are manually specified by a developer using some form a behavior representation language such as finite state machines, behavior trees, and rule-based systems. In reactive AI, a developer explains explicitly to an agent what it should do in each situation. Similarly for storytelling, stories are handled through a complex puzzle dependency graph (or quest graph) which is created manually by a developer. Creating AI in this way is known to be tedious and costly, and the resulting systems are very hard to read, debug, and upgrade.

### BRIEF DESCRIPTION OF THE DRAWINGS

Further features and advantages of the present invention will become apparent from the following detailed description, taken in combination with the appended drawings, in which:

FIG. 1 is a schematic illustrating a behavior generation system that includes a planning module and a machine learning module, in accordance with one embodiment;

FIG. 2 is a flowchart illustrating a behavior generation method, in accordance with one embodiment;

FIG. 3 is a flowchart illustrating a behavior generation system that includes a planning module and a machine learning module, in accordance with one embodiment;

FIG. 4 is a flowchart illustrating a behavior generation system that includes a machine learning module as a planning module, in accordance with one embodiment;

FIG. 5 is a block diagram illustrating an example software architecture, which may be used in conjunction with various hardware architectures described herein; and

FIG. 6 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes systems, methods, techniques, instruction sequences, and computing machine program products that constitute illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details.

In example embodiments, a method of behavior generation is disclosed. Planning state data in a planning domain language format is received and a state description and an associated action description based on the planning state data are generated. The state description and the associated action description are parsed into a series of tokens for a machine learning (ML) encoded state and associated ML encoded action. The series of tokens describe the state and the action. The ML encoded state and ML encoded action is processed with a recurrent neural network (RNN) to generate an estimate of a value of the state description and the action description. Output of the RNN is taken as input into a neural network to generate a value estimate for a state-action pair. The value estimate is a measure of a value of the state-action pair. A plan that includes a plurality of sequential actions for an agent is generated. The plurality of sequential actions is chosen based on at least the value estimate.

Many of the methods of the present invention may be performed with a digital processing system, such as a conventional, general purpose computer system. Special purpose computers which are designed or programmed to perform only one function may also be used. The present invention includes apparatuses which perform one or more operations or one or more combinations of operations described herein, including data processing systems which perform these methods and computer readable media which when executed on data processing systems cause the systems to perform these methods, the operations or combinations of operations including non-routine and unconventional operations.

The term ‘game’ used herein should be understood to include video games and applications that execute and present video games on a device, and applications that execute and present simulations on a device. The term ‘game’ should also be understood to include programming code (either source code or executable binary code) which is used to create and execute the game on a device.

The term ‘runtime’ used herein should be understood to include a time during which a program (e.g., an application, a video game, a simulation, and the like) is running, or executing (e.g., executing programming code). The term should be understood to include a time during which a video game is being played by a human user or an artificial intelligence agent.

The term ‘environment’ used throughout the description herein should be understood to include 2D digital environments (e.g., 2D video game environments, 2D simulation environments, and the like), 3D digital environments (e.g., 3D game environments, 3D simulation environments, 3D content creation environment, virtual reality environments, and the like), and augmented reality environments that include both a digital (e.g., virtual) component and a real-world component.

The term ‘game object’, used herein is understood to include any digital object or digital element within an environment. A game object can represent (e.g., in a corresponding data structure) almost anything within the environment; including characters, weapons, scene elements (e.g., buildings, trees, cars, treasures, and the like), backgrounds (e.g., terrain, sky, and the like), lights, cameras, effects (e.g., sound and visual), animation, and more. A game object is associated with data that defines properties and behavior for the object.

The terms ‘asset’, ‘game asset’, and ‘digital asset’, used herein are understood to include any data that can be used to describe a game object or can be used to describe an aspect of a game or project. For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more game objects within a game at runtime.

Throughout the description herein, the term “agent” and “AI agent” should be understood to include entities such as a non-player character (NPC), a robot, and a game world which are controlled by an artificial intelligence system or model.

In a paradigm called “deliberative AI”, instead of providing explicit behaviors to the agent under control (e.g., robot, NPC or game world), a model of rationality is provided to the agent and a problem solver determines the appropriate behavior in each encountered situation. The model of rationality requires a planning domain description language to describe the model of rationality to the AI.

Automated Planning uses deliberative AI and is a systematic approach to produce behaviors and solve planning problems. It may be used in autonomous and semi-autonomous systems (e.g., in robotics). An automated planning system may include three components: a planning domain description language, a behavior controller and a behavior planner. The planning domain description language (PDDL) also known as a planning domain language (PDL) can be used to define a model of a problem to solve, and an environment for an agent. The model is referred to as a planning domain and includes an artificial intelligence (AI) agent world model (e.g., facts of the world for the agent), and a set of actions the agent can execute to modify the world state. The planning domain allows a fair amount of controllability on the generated behaviors since the allowed actions can be controlled in each situation. Furthermore, the use of a language to describe the planning domain allows re-usability of a planning system since different problems can be represented in the same language.

The behavior controller monitors the evolution of a world/game/simulation and converts events therein (e.g., game events) into planning domain events (e.g., events as described with the PDL). It ensures that a world model for the behavior planner is in sync with the state of the game/simulation/real world, and is responsible for requesting and executing decisions from the behavior planner.

The behavior planner is a problem-solving module and requires the planning domain, the current state of the system (e.g., using the world model), and a goal to compute a plan to drive the system from the current state to a goal state. The plan includes a sequence of actions (or a sequence of sets of actions that can be executed simultaneously). The algorithms that underpin automated planners are classical AI search algorithms, that is, not machine learning.

Machine Learning (ML) is an approach to problem solving that contrasts strongly with automated planning. To solve a problem, a planner needs a well-defined and totally specified model (the planning domain). Designing the model amounts to providing some form of human intelligence. In contrast, ML systems are based on learning from data, without a human operator providing clues to the solution process with the exception of a reward function. Reinforcement learning (RL) is a subset of ML and learns behaviors and solves planning problems by interacting directly with the process that is to be controlled. For example, the formal model underpinning most RL algorithms is a planning problem where the parameters are initially unknown and must be learned through experience. The RL system is guided toward a goal through a reward function, which is a numerical value provided at each time step and indicates how well the system is performing. Through repeated experience, the AI learns to select actions that maximizes the future rewards (e.g., the sum of all future rewards). In this way, planning and RL pursue the same goal, but with radically different methods.

When applied to video games and simulations, many RL systems work in a pixel-to-control way while others use some form of fixed state description. That is, the RL system takes as input screenshots (e.g., pixel maps) produced by a game camera, and outputs explicit game controls (e.g., gamepad inputs). In robotics, the RL system directly maps sensorial input of a robot to the robot controls. The two examples illustrate that RL systems do not require any intelligence from a human expert (e.g., with the exception of the reward signal), and is in contrast with planning domains (used by planners) which contain much human intelligence. However, some ML systems have a richer, more informative input, but the systems are specialized to a single application (e.g., a single specific problem) using a hand-designed state and action representation that contains some intelligence. Unlike planners, there is no RL system that can be used for multiple problems from different domains.

RL has been unsuccessful in producing some types of behaviors. RL is good at low-scale sensory-motor tasks that are close to control tasks: steering a car, moving a paddle in a video game, aiming a gun while moving, etc. These tasks are characterized by the fact that, although they do require some amount of anticipation and prediction, the predictions are rather shallow (have a small planning depth) and do not anticipate more than a few seconds in the future to solve a task correctly. Also, these problems have a multi-dimensional continuous nature: they involved several continuous variables bounded by several forms of non-linear constraints and dependencies. In contrast, planners are good at tasks with large planning depth (that is, requiring anticipation and prediction over substantial duration), and that have a discrete and combinatorial nature (that is, non-continuous). Furthermore, RL systems are much less controllable than planners because RL systems rely only on a reward signal as a guide towards a goal, the system cannot be forced into a behavior.

In accordance with an embodiment, there is provided herein systems and methods for generating behavior using deep learning and an automatic planner. The system is part of a paradigm called “deliberative AI” where an agent under control (e.g., robot, NPC or game world), is provided with a model of rationality and a problem solver (e.g., a planning module) to determine appropriate behavior for the agent in each encountered situation. Throughout the description herein, the term “agent” should be understood to include entities such as a non-player character (NPC), a robot, and a game world which are controlled by an artificial intelligence system.

There is described herein a behavior generation system that can generate sequences of decisions or actions to solve a behavioral problem. In some embodiments, the behavior generation system can generate a state policy, wherein the policy provides a mapping for actions to be taken given an input state (e.g., state of a game, state of a robot, state of a world, or the like). Many AI systems perform single-shot decisions (e.g., recommending which ad to display to a user); however, the behavior generation system described herein produces sequences of decisions or actions to solve a problem. The behavior generation system described herein can be used for problem solving (e.g., to solve a planning problem faced by an autonomous robot), and for behavior generation (e.g., generating behavior for an AI agent) within an environment (e.g., industrial simulation, video game, XR).

The behavior generation system described herein is a mixed ML and planning system that uses both automated planning and machine learning (e.g., deep learning) to accomplish behavior generation (and decision making and problem solving). The combined system leverages the power of both automated planning and machine learning. Namely, the behavior generation system described herein can solve larger problems than current systems, thanks to the problem-solving power of machine learning as used herein. Furthermore, the behavior generation system described herein can create more controlled agents than machine learning allows on its own, thanks to the higher controllability of the planning system used herein. Additionally, the behavior generation system described herein can re-use the same behavior generation system to solve different problems in different domains, which is a characteristic of some automated planning systems, but one that has not been achieved by existing machine learning behavior systems. The planning domain is derived from a planning domain description language, and the behavior generation system described herein is designed to accept every problem expressed in the planning domain description language. In this way, the behavior generation system described herein has the benefit of re-usability (e.g., which comes from using a planning module) combined with the problem-solving power of ML, as described herein.

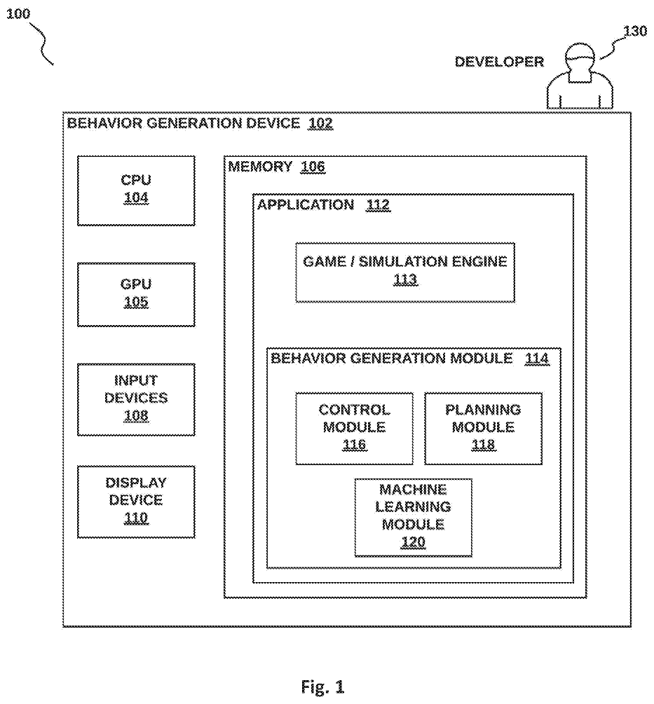

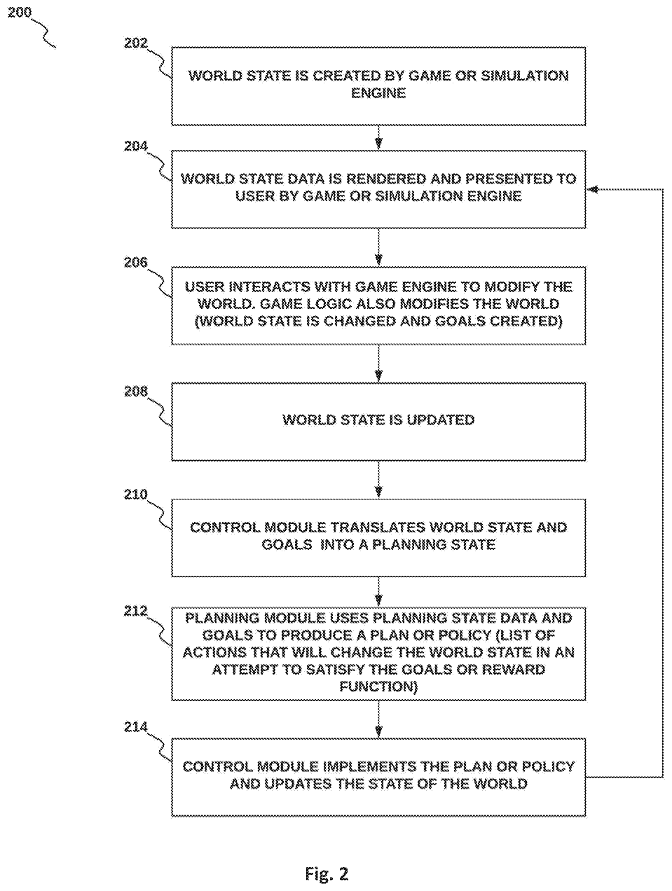

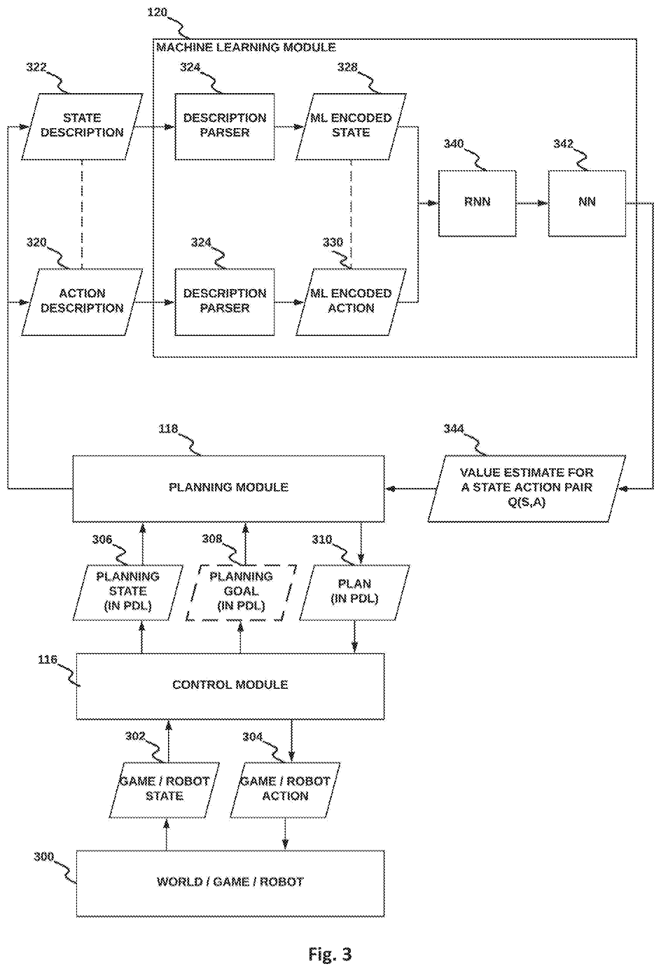

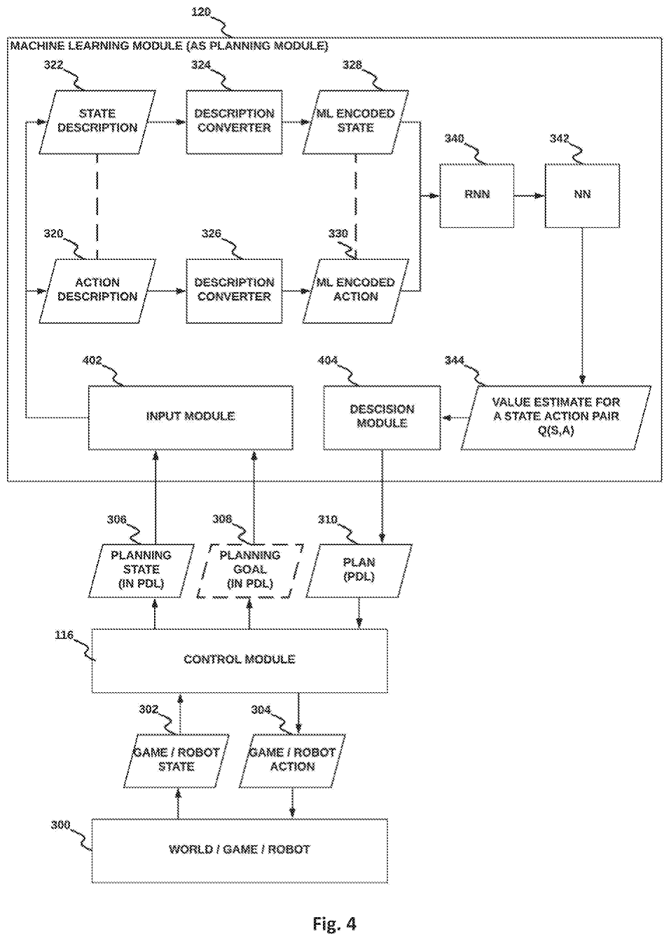

Turning now to the drawings, systems and methods for behavior generation using deep learning and an automatic planner, in accordance with embodiments of the invention are illustrated. In accordance with an embodiment, FIG. 1 is an illustration of a behavior generation system 100 using deep learning and an automatic planner. The behavior generation system 100 includes a behavior generation device 102, a processing device including one or more central processing units 104 (CPUs), one or more graphics processing units (GPUs) 105, a memory 106, an input device 108, and a display device 110. The input device 108 is any type of input unit such as a mouse, a keyboard, a touch screen, a joystick, a microphone, a camera, and the like, for inputting information in the form of a data signal readable by the processing device 104. The processing device 104 is any type of processor, processor assembly comprising multiple processing elements (not shown), having access to a memory 106 to retrieve instructions stored thereon, and execute such instructions. Upon execution of such instructions, the instructions implement the processing device 104 to perform a series of tasks as described herein (in particular with respect to FIG. 2, FIG. 3, and FIG. 4). The memory 106 can be any type of memory device, such as random-access memory, read only or rewritable memory, internal processor caches, and the like.

The display device 110 can include a computer monitor, a touchscreen, and a head mounted display, which may be configured to display digital content including video, a video game environment, and integrated development environment and a virtual simulation environment to a developer or user 130. The display device 110 is driven or controlled by the one or more GPUs 105 and optionally the CPU 104. The GPU 105 processes aspects of graphical output that assists in speeding up rendering of output through the display device 110.

The memory 106 can be configured to store an application 112 (e.g., a video game, a simulation, a virtual reality experience, an augmented reality experience) that communicates with the display device 110 and also with other hardware such as the input device(s) 108 to present the application to the developer 130. The application could include a game (or simulation) engine 113, the game engine 113 would typically include one or more modules that provide the following: animation physics for game objects, collision detection for game objects, rendering, networking, sound, animation, and the like in order to provide a video game (or simulation) environment for display on the display device 110. In accordance with an embodiment, the application 112 includes a behavior generation module 114 that provides various behavior generation functionality as described herein. In accordance with an embodiment, the behavior generation module 114 includes a control module 116, a planning module 118, and a machine learning module 120 as described herein. Each of the application 112, the behavior generation module 114, the control module 116 the planning module 118, and the machine learning module 120 includes computer-executable instructions residing in the memory 106 that are executed by the CPU 104 and optionally with the GPU 105 during operation. The application 112 includes computer-executable instructions residing in the memory 106 that are executed by the CPU 104 and optionally with the GPU 105 during operation in order to create a runtime application program such as a video game or simulator. The behavior generation module 114, the control module 116, the planning module 118, the machine learning module 120, and the game engine 113 may be integrated directly within the application 112, or may be implemented as an external pieces of software (e.g., plugins).

In accordance with an embodiment, the behavior generation module 114 includes a planning domain description language (PDDL) or simply a planning domain language (PDL) which includes data that defines a planning domain for the application 112. The planning domain is a definition of a problem to be solved (e.g., by an AI agent) within the application 112 and the PDL is the language in which the problem is described. As an example, when the problem involves generating agent behaviors, the planning domain includes a world model for the agent (e.g., facts about the world that are important for the agent), and a set of actions the agent can execute to modify a state of the world model. As another example, when the problem involves generating a story for storytelling, the planning domain includes important facts that can become true during a story, and the planning domain can also include events that can be triggered to advance the story (e.g., events can change a truth value of some facts).

In accordance with an embodiment, the behavior control module 116 monitors the evolution of a world (e.g., a game world, a simulation world and the real world) and converts a state of the world, including world events (e.g., game events), into a format described by the PDL and referred to herein as a planning state. The conversion may be part of operation 210 as described below with respect to the method 200 described in FIG. 2. As part of the conversion, the behavior control module 116 converts world events (e.g., game events) into planning domain events. A planning domain event is an event as described with the PDL. A planning domain event can include the deletion or creation of a planning domain object, the deletion or addition of a trait to a planning domain object, and the modification of the properties of a trait attached to a planning domain object. As part of the conversion, the behavior control module 116 converts game objects into planning domain objects. In a situation when behavior is generated for an agent such as an NPC and robot, the behavior control module 116 ensures that a world model (e.g., a model of the world) is always in sync with a current version of the state of the world model, and the module 116 is responsible for executing decisions from the planning module 118 for the agent. When behavior is generated for a story (e.g., storytelling), the behavior control module 116 monitors the truth value of important facts defined in the world model, and triggers world events to advance the story as decided by the planning module 118.

In accordance with an embodiment, the behavior control module 116 also keeps track of one or more goals for an AI agent. A goal can be an end result an agent must achieve, and a goal can be a state the world needs to pass through. For example, a goal given to the planning module 118 can be represented as a set of conditions a future state of the world model must satisfy. A goal for an AI agent can be specific (e.g., kill the nearest enemy) or abstract (e.g., stay alive as long as possible). In accordance with an embodiment, when the behavior generation module 114 is used for storytelling, a goal can be an event that the story is required to pass through.

In accordance with an embodiment, the behavior generation module 114 includes a behavior planning module 118. In accordance with an embodiment, the behavior planning module 118 solves problems by determining a plan that includes a sequence of actions (e.g., for an AI agent) that will achieve a goal. The plan is a list of actions to be carried out by the control module 116 (e.g., the actions applied to world objects) that will change the planning state (e.g., and world model state) in an attempt to satisfy the goals. The behavior planning module 118 receives as inputs a first state of the world model at a first time (e.g., the current state) and a goal for an agent. The goal is optional if a reward function is being used by the machine learning module 120. The inputs are received from the behavior control module 116. The behavior planning module 118 uses the inputs to compute a plan to drive the state of the world model from the first state to a goal state (e.g., a state in line with the received goal). Alternatively, the behavior planning module 118 can use the inputs to compute a plan that maximizes a reward function.

In accordance with an embodiment, the behavior generation module 114 includes a machine learning module 120. The planning module 118 uses input over time from the machine learning module 120 to improve the quality of output plans. The input from the machine learning module 120 includes estimates of a value of including an associated action in the output plans of the planner.

One benefit of a planning domain description language is to allow a single planning module 118 and a single control module 116 to be used on multiple problems provided each problem can be represented in the planning domain language. The control module 116, the planning module 118 and the machine learning module 120 can work on any problem expressed in the planning domain language.

The planning domain language described herein uses a planning domain object to represent an entity that is part of the world. For example, within a video game, a planning domain object can represent any game object, including: an enemy, a location in the game environment, and an object that can be manipulated.

In accordance with an embodiment and shown in FIG. 2, is a flowchart of a method 200 for the functioning of the control module 116 and the planning module 118 within the behavior generation module 114. The method 200 occurs during a runtime of the application 112 (e.g., during game play or simulation). At operation 202 of the method 200, a world model state is created by the game engine 113. The world model state includes data that describes game objects in the game world and describes game events in the game world at a time during runtime. At operation 204, the game engine 113 uses the world model state data to render part or all of the world and then display it via the display device 110. At operation 206, the user interacts with and modifies the world using the input device 108. The user could be playing a game (e.g., using a keyboard or joystick) or interacting with a simulation. The interaction of the user with the world changes the state of the world model (e.g., objects are moved, properties are changed, and the like) and optionally creates behavior goals for objects within the world. As part of operation 206, game logic (or simulation logic) also causes the game engine 113 to change the world model state (e.g., to change and optionally create goals). The game logic including instructions within the application 112 that causes the game engine 113 to perform operations on the world model data. At operation 208 the state of the world model is updated by the game engine 113 (e.g., the world model data is modified). At operation 210, the control module 116 converts the updated world model state and goals into a planning state. At operation 212, the planning module 118 uses planning state data (e.g., from operation 210) and optionally the goals (e.g., from operation 206) to produce a plan for the control module 116 to execute. As part of operation 212, the behavior planning module 118 receives as inputs a first state of the planning state at a first time (e.g., the current planning state) and a goal for an agent. The inputs are received from the behavior control module 116. The behavior planning module 118 uses the inputs to compute a plan to drive the planning state from the first state to a goal state (e.g., a planning state associated with the received goal). In accordance with some embodiments, the behavior planning module 118 uses the inputs to compute a state-conditioned policy so that the system supports non-deterministic outputs (e.g., if X occurs, do action 1. Otherwise, if Y occurs, do action 2.). The plan includes a series of actions for the controller to implement in the world. At operation 214, the control module 116 implements the plan (e.g., by implementing actions within the plan) and updates the state of the world model (e.g., modifies the data within the model). At the end of operation 214, the system loops back to operation 204.

In accordance with an embodiment and shown in FIG. 3 is a data flowchart for a behavior generation module 114 that includes both a planner and a ML module. The planning module 118 and control module 116 function as described in the method 200 of FIG. 2. As shown in FIG. 3, the planning module 118 uses input from a machine learning module 120 to improve the quality of a generated plan 310. The input 344 from the machine learning module 120 is a value estimate for a state-action pair, wherein the value estimate provides the planning module 118 with an estimate of a value of a potential action the control module 116 can implement for a planning state 306 and optionally a planning goal 308 input to the planning module 118. A state-action pair includes data describing a state and one or more associated actions (e.g., {current state, action 1}, {current state, action 2}, and the like). The planning module 118 uses the estimate 344 to efficiently evaluate (e.g., including ranking, choosing and eliminating) state-action pairs when exploring possible future states and actions available in the future states. In accordance with an embodiment, the planning state 306, the planning goal 308, and the plan 310 are all expressed in a planning domain language (PDL).

In accordance with an embodiment, there are a plurality of state descriptions 322 and action descriptions 320 sent from the planning module 118 to the ML module 120 (e.g., in batches). In accordance with an embodiment, a state description 322 is matched with an action description 320 in a state-action pair. The state descriptions 322 and action descriptions 320 represent future states and future actions the planning module 118 is evaluating, wherein the evaluating includes generating value estimates for each state action pair. A future state within a state-action pair represents a state that is reachable by taking the action of the state-action pair from a current state (e.g., the planning state 306). In accordance with an embodiment, the action within a state-action pair may include a plurality of actions to be performed in succession. In accordance with an embodiment, the state descriptions 322 and action descriptions 320 are parsed (e.g., by a description parser 324) into a ML encoded state description 328 and a ML encoded action description 330 respectively. The ML encoded state description 328 and the ML encoded action description 320 include descriptions which are compatible with a machine learning system within the ML module 120. The ML encoded state description 328 and the ML encoded action description 330 include a sequence of tokens. The tokens can include individual “words” that describe the states 322 and the actions 320, according to an associated representation in a PDL. For example, in a predicate-based PDL, there can be a state description that includes “AT(Tom, House)”, which could be converted into a ML encoded expression such as “AT Agent Tom Location House”, and the tokens would be [AT, Agent, Tom, Location, House].

In accordance with an embodiment, the sequence of tokens within the ML encoded state 328 and the sequence of tokens within the ML encoded action 330 are input into a recurrent neural network (RNN) 340 that produces the estimate 344 of the value of the planning state-action pair. In accordance with an embodiment, there is neural network (NN) 342 which produces the estimate 344 and whereby the RNN is used for embedding the state description 322 and action description 320 into a representation that can be put into the NN 342 for evaluation. An embodiment that included the RNN 340 and NN 342 would include an intermediate representation of the state description and action description which is passed as data between the RNN 340 and the NN 342 (the intermediate representation is not shown in FIG. 3). The intermediate representation (i.e., embedding) could be used for other processes including optimization and training of the RNN.

In accordance with an embodiment, the planning module 118 generates an output plan 310 (e.g., a policy) by maximizing a value (e.g., a sum of action costs and rewards) of actions taken between the current state and a future state plus an estimated value of states beyond the future state (e.g., as provided by the ML module 120 within the value estimates 344), not knowing what a user (e.g., game player) may do beyond the future state.

In accordance with an embodiment, the recurrent neural network 340 is trained using value estimates computed by the planning module 118 when exploring possible future states. The planning module 118 computes a policy that maximizes a sum of rewards between a first state (e.g., the current state) and a future goal state (e.g., a state associated with a planning goal 308). The planning module 118 can compute exact rewards between a first state and a planning horizon, wherein the planning horizon may or may not include the goal state. The planning horizon is a measure of how far into a future a planner can plan, wherein the measure may include a measure based on time, a measure based on a number of actions, and a measure based on a number of future states, and the like. Based on a goal state being within the horizon of a planner, the reward estimates are accurate. Based on the goal state being outside the horizon of a planner, the “missing” reward between the horizon and the goal may be estimated with a heuristic estimator. In this manner, without using machine learning, state-action value estimates can be collected for training by running the planning module 118 in simulation. The recurrent neural network 340 and optionally, the neural network 342 are trained with the collected value estimates, resulting in a trained machine learning module 120.

In accordance with an embodiment, the ML system module 120 works with an input of a variable size, wherein each input may be of different size (e.g., length). The input includes a state and action pair, which is a type of representation used by a planning system. The variable size inputs are dealt with by using the RNN 340 which includes a memory of previous inputs. Most existing ML systems are limited to fixed-size input (e.g., a picture with a fixed size, an animation of a fixed duration, and the like); however, planning domain states (e.g., state description 322) are usually represented as a collection of objects and facts whose size varies at runtime. For example, a first state could be represented by the following collection of 3 facts: 1) An NPC is in a house, 2) The NPC hunger level equals 5, and 3) the NPC has food. During the first state, the NPC could consider eating the food (e.g., using the planning module 118 to create a plan to eat the food), which would lead to a second state represented by the following 2 facts: 1) The NPC is in a house, and 2) the NPC hunger level equals 0. There is no more food and, as a consequence, the description of the second state (2 facts) is shorter than the description of the first state (3 facts). The variable size inputs are dealt with by using the RNN 340 which includes a memory of previous inputs. The facts for a state are presented to the NN 342 one fact at a time via the RNN 340.

In accordance with an embodiment and shown in FIG. 4, the behavior generation module 114 uses the ML system 120 as a planning module. The method 200 described in FIG. 2 is compatible with the system shown in FIG. 4, with operation 212 using the ML module 120 as the planning module. In the embodiment, the control module 116 provides the planning state 306 and optionally a planning goal 308 to an input module 402 that evaluates the state 306 (and optionally the goal 308) and provides an associated set of possible actions that can be implemented from the state 306. In accordance with an embodiment, the planning state 306, the planning goal 308, and the plan 310 are all expressed in a planning domain language (PDL). The state-action association (e.g., state-action pair) is shown in FIG. 4 with a dashed line between the state description 322 and the associated action description 322 as well as between the ML encoded state 328 and the associated ML encoded action 330. The input module 402 generates a state description 322 for the state 306 and an associated set of action descriptions 320 for a set of possible actions. In accordance with an embodiment, the state descriptions 322 and action descriptions 320 are parsed (e.g., by a description parser 324) into a ML encoded state description 328 and a ML encoded action description 330 respectively. The ML encoded state description 328 and the ML encoded action description 330 include a sequence of tokens. The tokens can include individual “words” that describe the states 322 and actions 320, according to an associated representation in a PDL. In accordance with an embodiment, the sequence of tokens is input into a recurrent neural network (RNN) 340 that produces an estimate 344 of the value of each state-action pair. In accordance with an embodiment, there is provided a neural network (NN) 342 which produces the estimate 344 and whereby the RNN is used for embedding the state description 322 and action description 320 into a representation that is compatible with the NN 342 for evaluation. An embodiment that includes the RNN 340 and NN 342 includes an intermediate representation of the state description and action description between the RNN 340 and the NN 342 (the intermediate representation is not shown in FIG. 4). The intermediate representation (i.e. embedding) could be used for other processes such as optimization or training of the RNN 340.

In accordance with an embodiment, the machine learning module 120 generates a one-step output plan 310 by using a decision module 404 that picks an action with the highest estimate value, and which is returned to the control module 116.

The ML system 120 within the behavior generation module 114 is not limited to the pixel-to-control method, nor is it limited to a specialized problem-specific representation.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor, the software configuring the processor as a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

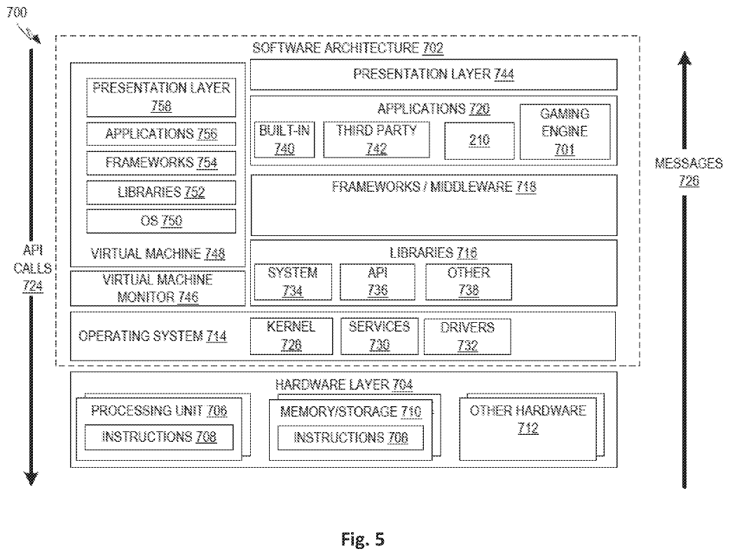

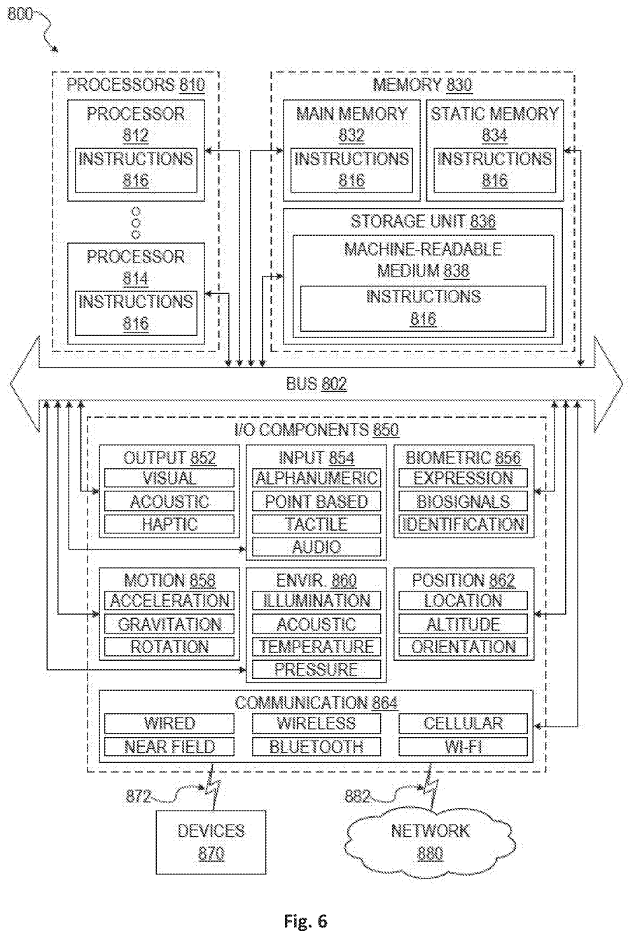

FIG. 5 is a block diagram 700 illustrating an example software architecture 702, which may be used in conjunction with various hardware architectures herein described to provide a gaming engine 701 and/or components of the behavior generation system 100. FIG. 5 is a non-limiting example of a software architecture and it will be appreciated that many other architectures may be implemented to facilitate the functionality described herein. The software architecture 702 may execute on hardware such as a machine 800 of FIG. 6 that includes, among other things, processors 810, memory 830, and input/output (I/O) components 850. A representative hardware layer 704 is illustrated and can represent, for example, the machine 800 of FIG. 6. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 5, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. In the example of FIG. 5, this is illustrated by a virtual machine 748. The virtual machine 748 creates a software environment where applications/modules can execute as if they were executing on a hardware machine (such as the machine 800 of FIG. 6, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 6 is a block diagram illustrating components of a machine 800, according to some example embodiments, configured to read instructions from a machine-readable medium (e.g., a machine-readable storage medium) and perform any one or more of the methodologies discussed herein. In some embodiments, the machine 110 is similar to the HMD 102. Specifically, FIG. 6 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include multi-core processor that may comprise two or more independent processors (sometimes referred to as “cores”) that may execute instructions contemporaneously. Although FIG. 6 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more of the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 6. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

1. A system comprising:
one or more computer processors;
one or more computer memories; and
one or more modules incorporated into the one or more computer memories, the one or more modules configuring the one or more computer processors to perform operations comprising:
receiving planning state data in a planning domain language format and generating a state description and an associated action description based on the planning state data;
parsing the state description and the associated action description into a series of tokens for a machine learning (ML) encoded state and associated ML encoded action, the series of tokens describing the state and the action;
processing the ML encoded state and ML encoded action with a recurrent neural network (RNN) to generate an estimate of a value of the state description and the action description;
taking output of the RNN as input into a neural network to generate a value estimate for a state-action pair, the value estimate being a measure of a value of the state-action pair; and
generating a plan that includes a plurality of sequential actions for an agent, wherein the plurality of sequential actions is chosen based on at least the value estimate.

2. The system of claim 1, wherein generating the state description and the associated action description includes receiving a planning goal expressed in the planning domain language.

3. The system of claim 1, wherein the series of tokens include individual words from the planning domain language.

4. The system of claim 1, wherein the recurrent neural network outputs an intermediate representation of the ML encoded state and the ML encoded action, the intermediate representation being input to a second neural network to generate an estimate of a value of the state description and the action description.

5. The system of claim 1, wherein the planning state data is received from a control module controlling an agent in an environment.

6. The system of claim 5, wherein the control module uses the plan to control the agent in the environment.

7. The system of claim 1, wherein the planning state data is received from a control module monitoring a truth value of facts defined in a world model and wherein the control module uses the plan to trigger world events to advance a story.

8. A method comprising:
receiving planning state data in a planning domain language format and generating a state description and an associated action description based on the planning state data;
parsing the state description and the associated action description into a series of tokens for a machine learning (ML) encoded state and associated ML encoded action, the series of tokens describing the state and the action;
processing the ML encoded state and ML encoded action with a recurrent neural network (RNN) to generate an estimate of a value of the state description and the action description;
taking output of the RNN as input into a neural network to generate a value estimate for a state-action pair, the value estimate being a measure of a value of the state-action pair; and
generating a plan that includes a plurality of sequential actions for an agent, wherein the plurality of sequential actions is chosen based on at least the value estimate.

9. The method of claim 8, wherein generating the state description and the associated action description includes receiving a planning goal expressed in the planning domain language.

10. The method of claim 8, wherein the series of tokens include individual words from the planning domain language.

11. The method of claim 8, wherein the recurrent neural network outputs an intermediate representation of the ML encoded state and the ML encoded action, the intermediate representation being input to a second neural network to generate an estimate of a value of the state description and the action description.

12. The method of claim 8, wherein the planning state data is received from a control module controlling an agent in an environment.

13. The method of claim 12, wherein the control module uses the plan to control the agent in the environment.

14. The method of claim 8, wherein the planning state data is received from a control module monitoring a truth value of facts defined in a world model and wherein the control module uses the plan to trigger world events to advance a story.

15. A non-transitory machine-readable storage medium storing a set of instructions that, when executed by one or more computer processors, cause the one or more computer processors to perform operations comprising:
receiving planning state data in a planning domain language format and generating a state description and an associated action description based on the planning state data;
parsing the state description and the associated action description into a series of tokens for a machine learning (ML) encoded state and associated ML encoded action, the series of tokens describing the state and the action;
processing the ML encoded state and ML encoded action with a recurrent neural network (RNN) to generate an estimate of a value of the state description and the action description;
taking output of the RNN as input into a neural network to generate a value estimate for a state-action pair, the value estimate being a measure of a value of the state-action pair; and
generating a plan that includes a plurality of sequential actions for an agent, wherein the plurality of sequential actions is chosen based on at least the value estimate.

16. The non-transitory machine-readable storage medium of claim 15, wherein generating the state description and the associated action description includes receiving a planning goal expressed in the planning domain language.

17. The non-transitory machine-readable storage medium of claim 15, wherein the series of tokens include individual words from the planning domain language.

18. The non-transitory machine-readable storage medium of claim 15, wherein the recurrent neural network outputs an intermediate representation of the ML encoded state and the ML encoded action, the intermediate representation being input to a second neural network to generate an estimate of a value of the state description and the action description.

19. The non-transitory machine-readable storage medium of claim 15, wherein the planning state data is received from a control module controlling an agent in an environment.

20. The non-transitory machine-readable storage medium of claim 19, wherein the control module uses the plan to control the agent in the environment.
